(19) United States
(12) Patent Application Publication
(10) Pub. No.: US 2005/0039498 A1
(43) Pub. Date: Feb. 24, 2005

(54) Trailer coupler locking device

(76) Inventor: Paul W. Budge, Washington, UT (US)

Correspondence Address: Thompson E. Fehr;Goldenwest Corporate Center, Suite 300, 5025 Adams Avenue, Ogden, UT, 84403, US

(21) Appl. No.: 10/771,214

(22) Filed: Feb. 2, 2004

Related U.S. Application Data
(60) Provisional application No. 60/444,381, filed on Feb. 3, 2003.

(51) Int. Cl. E05B 73/00; E05B 67/22; E05B 65/12

(52) U.S. Cl. 70/14; 70/39; 70/258

(57) ABSTRACT

A trailer coupler locking device having a shackle which has a top joined to two substantially straight legs with a curved section that is preferably a generally convex curve. The base contains a cylinder lock symmetrically located between two apertures for accommodating the substantially straight legs of the shackle. A plug member is located on top of the base; preferably the plug member is a stepped ball. Associated with the cylinder lock are two bolts, one of which has an end that enters the first aperture for the straight legs and another of which has an end that enters the second aperture for the straight legs. A blocking member works with the cylinder lock to control the movement of the straight legs and preferably has three positions for doing so which are associated with the positions of the preferred cylinder lock, which is a three-position lock.

### CROSS-REFERENCE TO RELATED APPLICATIONS

This is a continuation-in-part of a copending U.S. provisional application No. 60/444,381, filed on Feb. 3, 2003.

### BACKGROUND OF THE INVENTION

1. Field of the Invention

This invention relates to locking devices for trailer couplers, which are also called hitches, to deter the unauthorized towing of a trailer to which the coupler is attached.

2. Description of the Related Art

Several patent applications exist concerning locking devices for trailer couples. These include those described in United States patent application publication nos. US 2003/006581, US 2003/0020256 and US 2003/0205884.

The device of publication no. US 2003/0205884 appears to be the closest to the present invention.

That device includes a shackle 12 and a base 14 having a plug member 17; apertures 18 extending through the base 14, located on either side of the plug member 16, and designed to receive the distal ends 20, 22 of the shackle 12.

The shackle “. . . comprises an inverted, generally U-shaped member having a pair of arms 20, 22 interconnected by a curved end portion 24. Located on one arm 22 are a plurality of lock-engageable grooves 26 and tip 28. In the preferred embodiment, the other arm 20 has no grooves.”

“Integrally formed within the base 14 is a locking means which prevents the removal of the locking arms 20, 22 from the apertures 18.”

“The locking mechanism of the preferred embodiment comprises a key mechanism 42, a spring 44, and a bolt 40 moveable between a locked position and an unlocked position.”

In addition to patent applications, Trimax Corporation/Wyers Products Group of Englewood, Colo., sells a UMAX100 Universal Coupler Lock which resembles publication no. US 2003/0205884 except that the lock cylinder appears to be located symmetrically between the apertures which accommodate the ends of the shackle and that the shackle is bent inward once on each side between the ends and the top.

Applicant, though, believes his date of conception precedes that of the Trimax device and, possibly, even that of the device of publication no. US 2003/0205884.

### BRIEF SUMMARY OF THE INVENTION

The Trailer Coupler Locking Device of the present invention is of the same type as that described in publication no. US 2003/0205884 but adds a number of improvements thereto.

The present invention preferably has at least one indentation or step symmetrically located on each side of the shackle between the ends of the shackle and the top of the shackle formed by inserting a convex curve at an intermediate point of the otherwise concave curve which forms a curved section of the shackle between the top of the shackle and each leg of the shackle.

The cylinder lock of the present invention is preferably a three-position lock. In addition to the two positions of the cylinder lock of publication no. US 2003/0205884, the cylinder lock of the present invention preferably precludes the bolts the ends of which are serrated and mate with the serrated sides of the shackle so as to create a racheting-type engagement from moving toward the springs which bias such locks.

The top of the shackle in the present invention preferably extends horizontally forward in order to accommodate a variety of trailer couplers.

And the plug member of the present invention is, preferably, shaped to fit snuggly more than one size of female portion of a trailer coupler.

### BRIEF DESCRIPTION OF THE SEVERAL VIEWS OF THE DRAWING

FIG. 1 is a lateral view of the Trailer Coupler Locking Device.

FIG. 2 is a cutaway view showing the interaction between the locking cylinder and the bolts.

FIG. 3 illustrates the mating faces of the shackle and the bolts.

FIG. 4 is a view looking down on the top of the shackle.

FIG. 5 is a lateral view of the rear of the Trailer Coupler Locking Device.

### DETAILED DESCRIPTION OF THE INVENTION

The present Trailer Coupler Locking Device comprises a shackle 1 and a base 2.

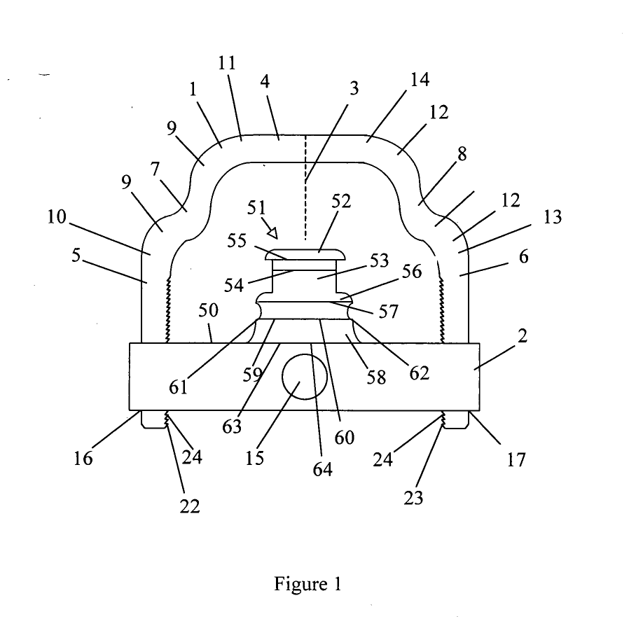

The shackle 1 is substantially symmetrical about its longitudinal axis 3, having a top 4 and two substantially straight legs 5, 6. Each leg 5, 6 is joined to the top 4 with a curved section 7, 8. Each curved section 7, 8 is preferably a generally convex curve. For the purposes of this patent application, “generally convex” means that one or more convex curves 9 exist between the first end 10 and the second end 11 of the first curved section 7 and that one or more convex curves 12 exist between the first end 13 and the second end 14 of the second curved section 8, as seen in FIG. 1.

The base 2 contains a cylinder lock 15 and two apertures 16, 17 symmetrically located about the cylinder lock 15 in order to accommodate the legs 5, 6.

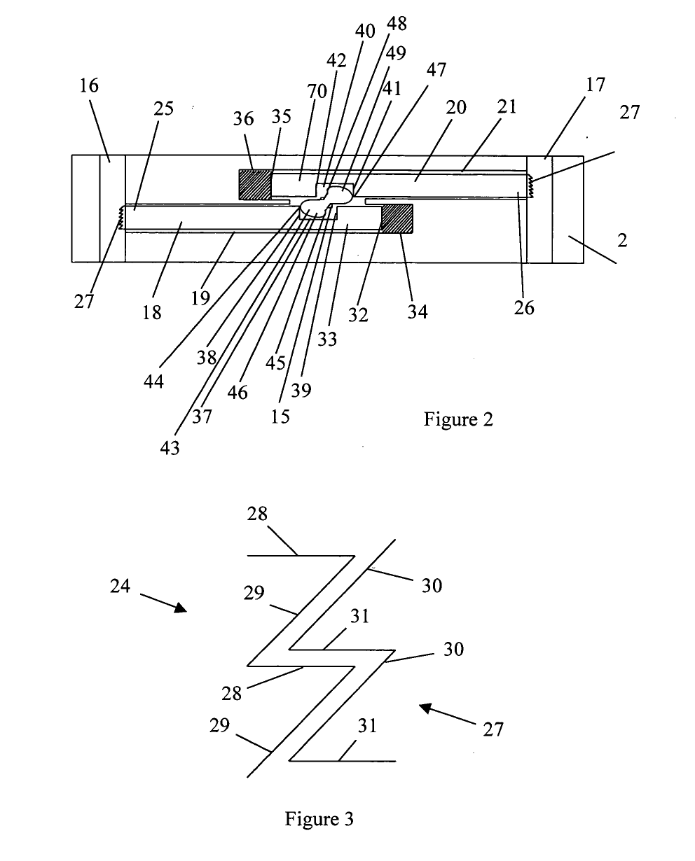

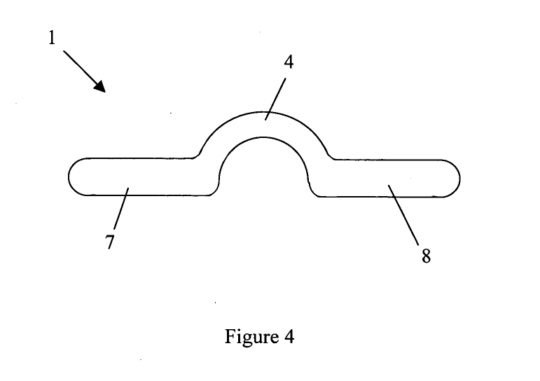

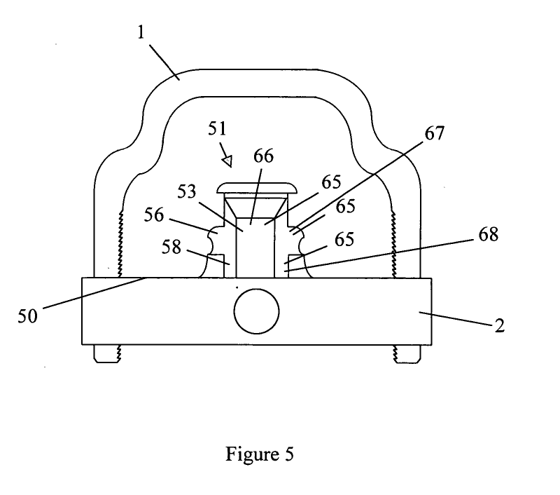

A first bolt 18 extends through a first cavity 19 in the base 2 into the first aperture 16, and a second bolt 20 extends through a second cavity 21 in the base 2 into the second aperture 17, as seen in FIG. 2.

At least the inside lower end 22 of the first leg 5 and at least the inside lower end 23 of the second leg 6 have serrations 24, as shown in FIG. 1, FIG. 2, and FIG. 3. Similarly, a first, or mating, end 25 of the first bolt 18 and a first, or mating, end 26 of the second bolt 20 have mating serrations 27.

The serrations 24 have a substantially horizontal upper face 28 and a lower face 29 that slopes downward and inward. The mating serrations 27 have an upper face 30 that slopes outward and downward and a lower face 31 which is substantially horizontal.

In contact with an inner end 32 or an intermediate portion 33 of the first bolt 18 is a first spring 34 which urges the first bolt 18 outward; similarly, in contact with an inner end 35 or an intermediate portion 70 of the second bolt 20 is a second spring 36 that urges the second bolt 20 outward. Each spring 34, 36 is, of course, also in contact with the base 2 in order to be able to provide the requisite urging force.

The first bolt 18 has a channel 37 with a first end 38 and a second end 39 with such channel 37 oriented toward a channel 40 in the second bolt 20. The channel 40 also has a first end 41 and a second end 42.

Rotatably connected to the cylinder lock 15 is a blocking member 43 of such shape and size that in a first position, when the first end 25 of the first bolt 18 and the first end 26 of the second bolt 20 are within the first aperture 16 and the second aperture 17, respectively, and in contact with the serrated legs 5, 6 if such legs 5, 6 are sufficiently far down in the apertures 16, 17, neither a first side 44 nor a second side 45 of a first end 46 of the blocking member 43 will touch either the first end 38 or the second end 39 of the channel 37 and neither a first side 47 nor a second side 48 of the second end 49 of the blocking member 43 touches either the first end 41 or the second end 42 of the channel 40. Thus, in the first position, the bolts 18, 20 are moved outward by the springs 34, 36 but can be forced inward. Then the serrated legs 5, 6 of the shackle 1 can be pushed farther into the apertures 16, 17 but not pulled farther upward; for the purposes of this patent application, this effect is termed “ratcheting” the legs 5, 6.

The blocking member 43 is also sized and shaped such that in a second position the second side 45 of the first end 46 of the blocking member 43 will touch the second end 39 of the channel 37 when the second side 48 of the second end 49 of the blocking member 43 touches the second end 42 of the channel 40. As the blocking member 43 is rotated from the first-position to the second position, the size and shape of the blocking member 43 are such that the blocking member 43 pulls the mating end 25 of the first bolt 18 and the mating end 26 of the second bolt 20 inward to such an extent that the mating ends 25, 26 no longer project into the apertures 16, 17. Then, naturally, the legs 5, 6 can be pushed farther into the apertures 16, 17 or pulled farther up the apertures 16, 17.

Finally, the blocking member 43 is preferably sized and shaped such that in a third position the first side 44 of the first end 46 of the blocking member 43 will touch the first end 38 of the channel 37 in the first bolt 18 while the first side 47 of the second end 49 of the blocking member 43 touches the first end 41 of the channel 40 in the second bolt 20. In this third position, the blocking member 43 precludes both bolts 18, 20 from moving inward and, therefore precludes any movement by the serrated legs 5, 6.

Preferably, the cylinder lock 15 is a three-position lock with such positions corresponding with the positions described above for the blocking member 43.

Also preferably, the top 4 of the shackle 1 extends forward in a substantially horizontal plane in order to accommodate some types of trailer couplers.

And attached to, as well as on the top 50 of, the base 2 is located a plug member 51 which fits inside the female portion of a trailer coupler to preclude the base from being twisted from such female portion. Preferably, the plug member 51 comprises an upper disc 52 attached to and above a cylinder 53 having a diameter 54 smaller than the diameter 55 of the upper disc 52, a lower disc 56 connected to and below the cylinder 53 and having a diameter 57 larger than the diameter 55 of the upper disc 52, and a concave skirt 58 attached to and below the lower disc 56. At an intermediate point 59 of the concave skirt 58, approximately where the diameter 60 of the concave skirt 58 equals the diameter 57 of the lower disc 56, a convex curve 61 creates a ridge 62 on the concave skirt 58. At its lower end 63 the concave skirt 58 has a diameter 64 which exceeds the diameter 57 of the lower disc 56.

A depression 65 exists in the rear 66 of the cylinder 53, the rear 67 of the lower disc 56, and the rear 68 of the concave skirt 58 in order to accommodate the projecting movable slide of the female portion of a trailer coupler.

When constructed as described in the immediately preceding two paragraphs, the plug member 51 shall be termed a stepped ball. The stepped ball fits the female portion of a variety of trailer couplers, both different sizes and designs of couplers.

As used herein, the term “substantially” indicates that one skilled in the art would consider the value modified by such terms to be within acceptable limits for the stated value. Also as used herein the term “preferable” or “preferably” means that a specified element or technique is more acceptable than another but not that such specified element or technique is a necessity.

1. A trailer coupler locking device, which comprises:
a shackle having a top, two substantially straight legs with each substantially straight leg being joined to the top with a curved section, and a longitudinal axis about which said shackle is substantially symmetrical;
a cylinder lock;
a base containing said cylinder lock, two apertures symmetrically located about said cylinder lock in order to accommodate the straight legs of said shackle, a first cavity extending into a first of the two apertures, and a second cavity extending into a second of the two apertures;
a means for ratcheting the straight legs of said shackle;
a first bolt connected to said cylinder lock and extending through the first cavity of said base;
a second bolt connected to said cylinder lock and extending through the second cavity of said base;
a means for ratcheting the legs of said shackle; and
a plug member attached to the top of said base.

2. The trailer coupler locking device as recited in claim 1, wherein:
each curved section is a generally convex curve.

3. The trailer coupler locking device as recited in claim 2, wherein:
the means for ratcheting the straight legs of said shackle comprises:
at least an inside lower end of the first leg of said shackle having serrations with each serration having a substantially horizontal upper face and a lower face that slopes downward and inward;
at least an inside lower end of the second leg of said shackle having serrations with each serration having a substantially horizontal upper face and a lower face that slopes downward and inward;
a first end of said first bolt having mating serrations with each mating serration having an upper face that slopes outward and downward and a lower face which is substantially horizontal;
a first end of said second bolt having mating serrations with each mating serration having an upper face that slopes outward and downward and a lower face which is substantially horizontal;
a first spring in contact with said first bolt and to said base so as to urge said first bolt outward;
a second spring in contact with said second bolt and to said base so as to urge said first bolt outward;
said first bolt having a channel with a first end and a second end with such channel oriented toward a channel in said second bolt, the channel in said second bolt having a first end and a second end;
a blocking member rotatably connected to said cylinder lock, said blocking member being of such shape and size that in a first position, when the first end of said first bolt and the first end of said second bolt are within the first aperture and the second aperture, respectively, and in contact with the serrated first and second legs of said shackle if such serrated legs are sufficiently far down in the first and second apertures, neither a first side nor a second side of a first end of said blocking member will touch either the first end or the second end of the channel in said first bolt and neither a first side nor a second side of a second end of said blocking member touches either the first end or the second end of the channel in said second bolt, and said blocking member also being sized and shaped such that in a second position the second side of the first end of the blocking member touches the second end of the channel in the first bolt when the second side of the second end of the blocking member touches the second end of the channel in the second bolt.

4. The trailer coupler locking device as recited in claim 3, wherein:
said plug member is a stepped ball.

5. The trailer coupler locking device as recited in claim 4, wherein:
said blocking member is further sized and shaped such that in a third position the first side of the first end of said blocking member touches the first end of the channel in the first bolt while the first side of the second end of the blocking member touches the first end of the channel in the second bolt; and
said cylinder lock is a three-position lock with such positions corresponding with the three positions of said blocking member.

6. The trailer coupler locking device as recited in claim 5, wherein:
the top of said shackle extends forward in a substantially horizontal plane.

7. The trailer coupler locking device as recited in claim 4, wherein:
the top of said shackle extends forward in a substantially horizontal plane.

8. The trailer coupler locking device as recited in claim 3, wherein:
said blocking member is further sized and shaped such that in a third position the first side of the first end of said blocking member touches the first end of the channel in the first bolt while the first side of the second end of the blocking member touches the first end of the channel in the second bolt; and
said cylinder lock is a three-position lock with such positions corresponding with the three positions of said blocking member.

9. The trailer coupler locking device as recited in claim 8, wherein:
the top of said shackle extends forward in a substantially horizontal plane.

10. The trailer coupler locking device as recited in claim 3, wherein:
the top of said shackle extends forward in a substantially horizontal plane.

11. The trailer coupler locking device as recited in claim 2, wherein:
said plug member is a stepped ball.

12. The trailer coupler locking device as recited in claim 11, wherein:
said blocking member is further sized and shaped such that in a third position the first side of the first end of said blocking member touches the first end of the channel in the first bolt while the first side of the second end of the blocking member touches the first end of the channel in the second bolt; and
said cylinder lock is a three-position lock with such positions corresponding with the three positions of said blocking member.

13. The trailer coupler locking device as recited in claim 12, wherein:
the top of said shackle extends forward in a substantially horizontal plane.

14. The trailer coupler locking device as recited in claim 2, wherein:
said blocking member is further sized and shaped such that in a third position the first side of the first end of said blocking member touches the first end of the channel in the first bolt while the first side of the second end of the blocking member touches the first end of the channel in the second bolt; and
said cylinder lock is a three-position lock with such positions corresponding with the three positions of said blocking member.

15. The trailer coupler locking device as recited in claim 14, wherein:
the top of said shackle extends forward in a substantially horizontal plane.

16. The trailer coupler locking device as recited in claim 2, wherein:
the top of said shackle extends forward in a substantially horizontal plane.

17. The trailer coupler locking device as recited in claim 1, wherein:
the means for ratcheting the straight legs of said shackle comprises:
at least an inside lower end of the first leg of said shackle having serrations with each serration having a substantially horizontal upper face and a lower face that slopes downward and inward;
at least an inside lower end of the second leg of said shackle having serrations with each serration having a substantially horizontal upper face and a lower face that slopes downward and inward;
a first end of said first bolt having mating serrations with each mating serration having an upper face that slopes outward and downward and a lower face which is substantially horizontal;
a first end of said second bolt having mating serrations with each mating serration having an upper face that slopes outward and downward and a lower face which is substantially horizontal;
a first spring in contact with said first bolt and to said base so as to urge said first bolt outward;
a second spring in contact with said second bolt and to said base so as to urge said first bolt outward;
said first bolt having a channel with a first end and a second end with such channel oriented toward a channel in said second bolt, the channel in said second bolt having a first end and a second end;
a blocking member rotatably connected to said cylinder lock, said blocking member being of such shape and size that in a first position, when the first end of said first bolt and the first end of said second bolt are within the first aperture and the second aperture, respectively, and in contact with the serrated first and second legs of said shackle if such serrated legs are sufficiently far down in the first and second apertures, neither a first side nor a second side of a first end of said blocking member will touch either the first end or the second end of the channel in said first bolt and neither a first side nor a second side of a second end of said blocking member touches either the first end or the second end of the channel in said second bolt, and said blocking member also being sized and shaped such that in a second position the second side of the first end of the blocking member touches the second end of the channel in the first bolt when the second side of the second end of the blocking member touches the second end of the channel in the second bolt.

18. The trailer coupler locking device as recited in claim 17, wherein:
said plug member is a stepped ball.

19. The trailer coupler locking device as recited in claim 18, wherein:
said blocking member is further sized and shaped such that in a third position the first side of the first end of said blocking member touches the first end of the channel in the first bolt while the first side of the second end of the blocking member touches the first end of the channel in the second bolt; and
said cylinder lock is a three-position lock with such positions corresponding with the three positions of said blocking member.

20. The trailer coupler locking device as recited in claim 19, wherein:
the top of said shackle extends forward in a substantially horizontal plane.

21. The trailer coupler locking device as recited in claim 18, wherein:
the top of said shackle extends forward in a substantially horizontal plane.

22. The trailer coupler locking device as recited in claim 17, wherein:
said blocking member is further sized and shaped such that in a third position the first side of the first end of said blocking member touches the first end of the channel in the first bolt while the first side of the second end of the blocking member touches the first end of the channel in the second bolt; and
said cylinder lock is a three-position lock with such positions corresponding with the three positions of said blocking member.

23. The trailer coupler locking device as recited in claim 22, wherein:
the top of said shackle extends forward in a substantially horizontal plane.

24. The trailer coupler locking device as recited in claim 17, wherein:
the top of said shackle extends forward in a substantially horizontal plane.

25. The trailer coupler locking device as recited in claim 1, wherein:
said plug member is a stepped ball.

26. The trailer coupler locking device as recited in claim 25, wherein:
said blocking member is further sized and shaped such that in a third position the first side of the first end of said blocking member touches the first end of the channel in the first bolt while the first side of the second end of the blocking member touches the first end of the channel in the second bolt; and
said cylinder lock is a three-position lock with such positions corresponding with the three positions of said blocking member.

27. The trailer coupler locking device as recited in claim 26, wherein:
the top of said shackle extends forward in a substantially horizontal plane.

28. The trailer coupler locking device as recited in claim 25, wherein:
the top of said shackle extends forward in a substantially horizontal plane.

29. The trailer coupler locking device as recited in claim 1, wherein:
said blocking member is further sized and shaped such that in a third position the first side of the first end of said blocking member touches the first end of the channel in the first bolt while the first side of the second end of the blocking member touches the first end of the channel in the second bolt; and
said cylinder lock is a three-position lock with such positions corresponding with the three positions of said blocking member.

30. The trailer coupler locking device as recited in claim 29, wherein:
the top of said shackle extends forward in a substantially horizontal plane.

31. The trailer coupler locking device as recited in claim 1, wherein:
the top of said shackle extends forward in a substantially horizontal plane.
